(19) United States
(12) Patent Application Publication
(10) Pub. No.: US 2021/0248165 A1
(43) Pub. Date: Aug. 12, 2021

(54) Pipeline Template Configuration in a Data Processing System

(71) Applicant: Arm IP Limited, Cambridge (GB)

(72) Inventor: John Ronald Fry, Campbell, CA (US)

(73) Assignee: Arm IP Limited, Cambridge (GB)

(21) Appl. No.: 17/252,852

(22) PCT Filed: Jun. 17, 2019
(86) PCT No.: PCT/GB2019/051677

§ 371 Date: Dec. 16, 2020

Related U.S. Application Data
(60) Provisional application No. 62/686,423, filed on Jun. 18, 2018.
(60) Provisional application No. 62/686,431, filed on Jun. 18, 2018.
(60) Provisional application No. 62/686,439, filed on Jun. 18, 2018.
(60) Provisional application No. 62/686,445, filed on Jun. 18, 2018.

(30) Foreign Application Priority Data
Jul. 31, 2018 (GB) 1812431.3
Jul. 31, 2018 (GB) 1812432.1
Jul. 31, 2018 (GB) 1812433.9
Jul. 31, 2018 (GB) 1812435.4

(51) Int. Cl. G06F 16/28; G06F 16/21

(52) U.S. Cl. CPC G06F 16/285; G06F 16/212

(57) ABSTRACT

A technology is provided for generating a data digest template for configuring a pipeline in a data digest system, comprising: receiving a pipeline description comprising a set of pipeline parameters operable by the data digest system, the pipeline parameters comprising at least one of a data source device descriptor, a communication channel descriptor, a flow dependency and a consuming application constraint; storing the pipeline description for modification and reuse; compiling the pipeline description using a template compiler to generate a compiled template; storing the compiled template for modification and reuse; mapping the compiled template into at least one data digest system configuration block; storing the at least one data digest system configuration block for modification and reuse; and supplying the at least one data digest system configuration block to the data digest system to configure the pipeline.

The present technology relates to methods and apparatus for the control of pipeline processing in a system configured to perform consumption driven data contextualization by means of reusable and/or modifiable templates. In particular, a data digest system operates by means of data gathering, data analytics and value-based exchange of data.

As the computing art has advanced, and as processing power, memory and the like resources have become commoditised and capable of being incorporated into objects used in everyday living, there has arisen what is known as the Internet of Things (IoT). Many of the devices that are used in daily life for purposes connected with, for example, transport, home life, shopping and exercising are now capable of incorporating some form of data collection, processing, storage and production in ways that could not have been imagined in the early days of computing, or even quite recently. Well-known examples of such devices in the consumer space include wearable fitness tracking devices, automobile monitoring and control systems, refrigerators that can scan product codes of food products and store date and freshness information to suggest buying priorities by means of text messages to mobile (cellular) telephones, and the like. In industry and commerce, instrumentation of processes, premises, and machinery has likewise advanced apace. In the spheres of healthcare, medical research and lifestyle improvement, advances in implantable devices, remote monitoring and diagnostics and the like technologies are proving transformative, and their potential is only beginning to be tapped.

In an environment replete with these devices, there is an abundance of data available for processing by analytical systems enriched with artificial intelligence, machine learning and analytical discovery techniques to produce valuable insights, provided that the data can be appropriately digested and prepared for the application of analytical tools.

Difficulties abound in this field, particularly when data is sourced from a multiplicity of incompatible devices, over a multiplicity of incompatible communications channels and consumed by a large, varied and constantly-evolving set of data analysis tools and systems. It would, in such cases, be desirable to enable consumers of data to specify their data needs without requiring technical information about the data such as how the data is formatted by the data source device, where its source is located, how it is delivered across a network, and how it has been manipulated on its way to the consuming data analysis system.

In a first approach to some of the many difficulties encountered in appropriately controlling data digest systems to assist in generating usable information, the presently disclosed technology provides a machine implemented method for generating a data digest template for configuring a pipeline in a data digest system, the method comprising: receiving a pipeline description comprising a set of pipeline parameters operable by the data digest system, the pipeline parameters comprising at least one of a data source device descriptor, a communication channel descriptor, a flow dependency and a consuming application constraint; storing the pipeline description for modification and reuse; compiling the pipeline description using a template compiler to generate a compiled template; storing the compiled template for modification and reuse; mapping the compiled template into at least one data digest system configuration block; storing the at least one data digest system configuration block for modification and reuse; and supplying the at least one data digest system configuration block to the data digest system to configure the pipeline.

In a hardware approach, there is provided electronic apparatus comprising logic operable to implement the methods of the present technology.

Implementations of the disclosed technology will now be described, by way of example only, with reference to the accompanying drawings, in which:

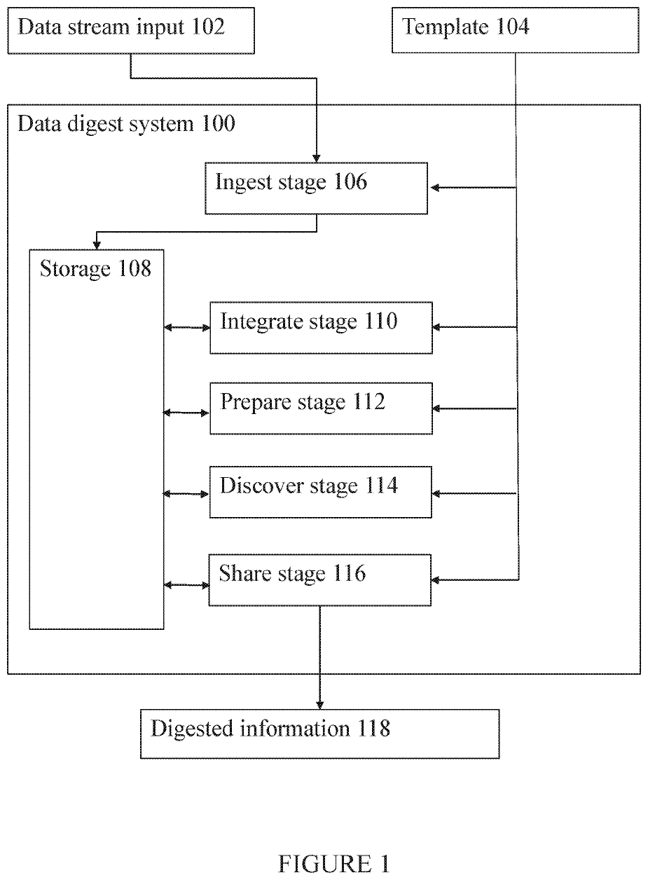

FIG. 1 shows a block diagram of an arrangement of logic, firmware or software components comprising a data digest system in which the presently described technology may be implemented;

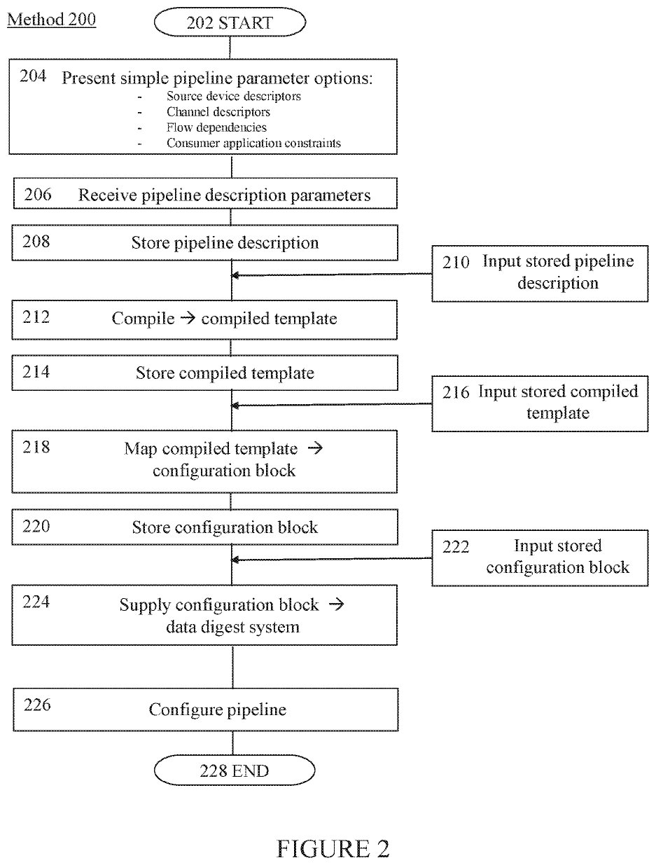

FIG. 2 shows an example of an arrangement of logic, firmware or software components incorporating a pipeline configuration template according to an implementation of the presently described technology;

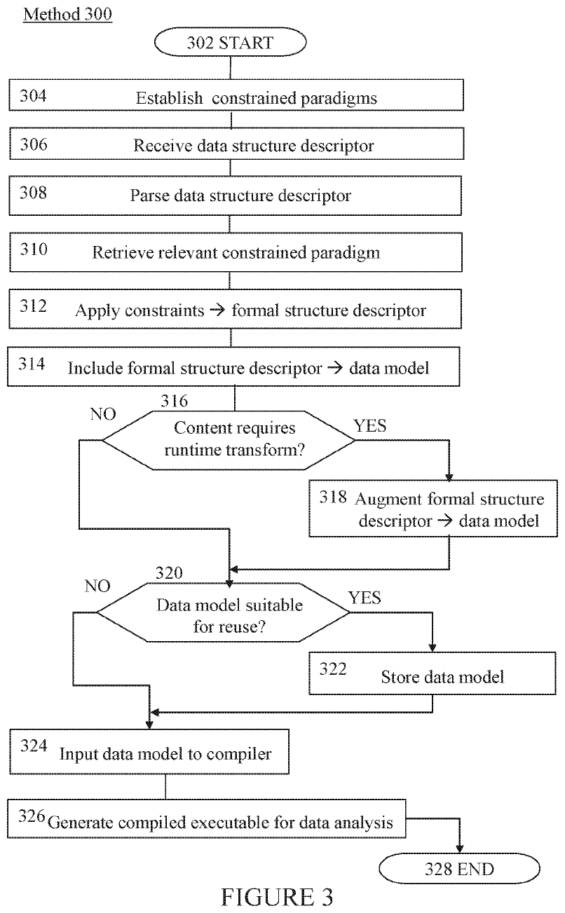

FIG. 3 shows one example of a computer-implemented method according to an implementation of the presently described data digest technology;

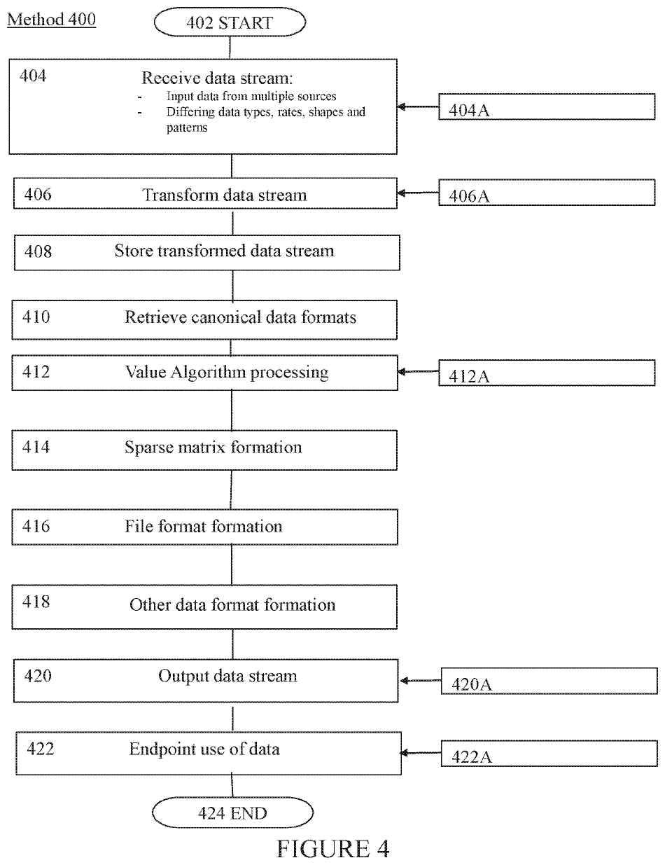

FIG. 4 shows a further example of a computer-implemented method according to an implementation of the presently described data digest technology;

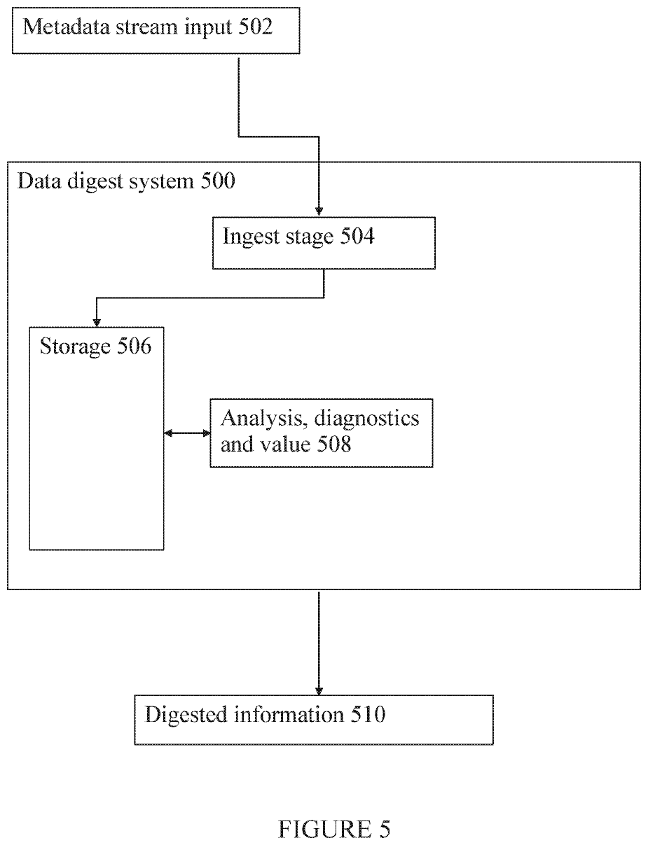

FIG. 5 shows a further example of an arrangement of logic, firmware or software components according to an implementation of the presently described data digest technology;

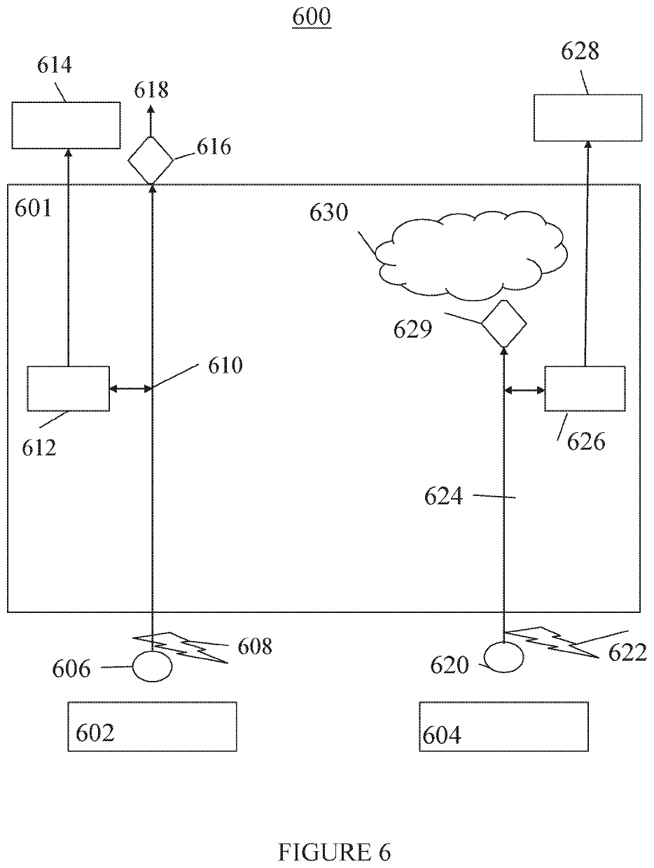

FIG. 6 shows a further example of an arrangement of logic, firmware or software components according to an implementation of the presently described data digest technology; and

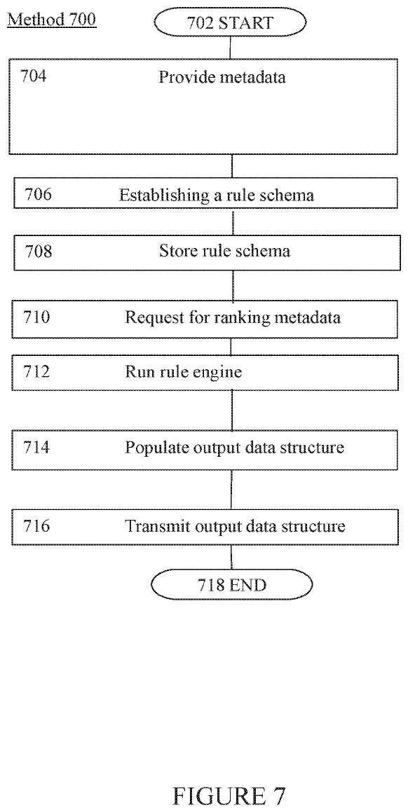

FIG. 7 shows a further example of a computer-implemented method according to an implementation of the presently described data digest technology.

The present technology thus provides computer-implemented techniques and logic apparatus for providing templates that enable data to be sourced from large numbers of heterogeneous devices and made available in forms suitable for processing by many different analysis and learning systems without requiring users to understand the technicalities of the data digest processing pipeline from the data source to the consuming data analysis tool. At the same time, the desideratum of flexibility to allow more sophisticated tuning of the processing pipeline can be accommodated by permitting templates to be stored at different developmental stages, so that they may be modified by more technically competent users and reused to configure pipelines tailored to meet more advanced needs.

The present technology is operable as part of a data digest service that can ingest data from a wide range of source devices, process it into one or more internal representations and then enable access to the data to one or more subscribers wishing to access the content.

Existing data analysis systems for capturing and handling streamed data, such as data from IoT data source devices, are typically producer-specific and thus limited to producing producer-defined data structures, handling data from specific products or nodes as it was formatted by those products and nodes, and using tailored analysis solutions—these data analysis systems are thus not adaptable and do not scale or integrate well in systems having consumers needing different data for different purposes, provided by a variety of different devices from different manufacturers with different data rates, different communications bandwidths and different types and formats of content. The present technology addresses at least some of the difficulties inherent in developing the necessary systems and platforms to analyse data in the modern data space with its massive proliferation of data source devices and data analysis systems.

It achieves this by providing technologies to enable device data to be monitored and analysed without users needing to directly interact with the physical devices and their raw data streams, or with any of the internal data handling required to make the data consumable, thereby enabling a more efficient, scalable and reusable system for accessing the data provided by large numbers of heterogeneous data source nodes to a variety of differently-configured data consumer applications. This is implemented in the various implementations by providing a templating system whereby users can specify in simple ways the sourcing, in-pipeline handling, and onward presentation of data.

In one implementation, for example, users may use a set of constrained language paradigms (in effect, a set of selectable list items arranged according to their functions and the stages of processing in the data digest processing pipeline) to define the parameters that determine the configuration of the pipeline through which data passes from the ingesting of data from the data source through to the provision of data arranged and formatted for consumption by the consuming data analysis system. The constrained language paradigms may be provided to the user in any suitable form, such as, for example, a user interface text form, a graphical user interface drag-and-drop design canvas, or the like.

The templates produced in this way are converted into sets of technical parameters and constraints that configure the entire data digest pipeline ready for runtime treatment of data streams received from data source devices.

In FIG. 1, there is shown a much-simplified block diagram of an exemplary data digest system 100 comprising logic components, firmware components or software components by means of which the presently described technology may be implemented. Data digest system 100 is operable to receive data stream input 102, which may be, for example, a real-time data feed, and to produce digested information 118 suitably prepared for use in analytical processing. Data stream input 102 may, alternatively, comprise data that has been stored in some form of data storage and either streamed out later in the form of a live real-time data stream or it may be batched out and presented in the form of blocks of prepared virtualized device data.

Data digest system 100 is thus operable to receive as input a data stream formed from multiple sources of data having differing formats and data rates. For example, an IoT sensor data source device such as a weather station will typically produce periodical data bursts comprising data fields for temperature, wind speed and direction, barometric pressure, and the like. By contrast, a safety-critical wear sensor in a railway transport system may produce a near-constant repetitive data flow comprising only a single type of data reading. In another case, a water leakage detector in a water supply line may produce no output for long periods, and may then begin to emit warning readings at shorter and shorter intervals as a leak worsens.

Data digest system 100 comprises ingest stage 106 operable to receive input data, which it may pre-process, for example, to render the data suitable for storage in storage component 108 and for further processing, wherein storage 108 may be operable as a working store or scratchpad for intermediate data under investigation by other stages 110, 112, 114, 116. Storage 108 may comprise any of the presently known storage means, such as main system memory, disk storage or solid-state storage, and any future storage means that are suited to the storage and retrieval of digital or analogue data in any form. Data digest system 100 further comprises integrate stage 110, prepare stage 112, discover stage 114, and share stage 116. These stages may be operable in any order, and plural stages may be operable at the same time or iteratively in a more complex refinement process. It will be immediately clear to one of skill in the art that the order in which the stages are shown in the present drawing figure does not imply any sequence constraint.

Integrate stage 110 is operable to form combinations of data according to predetermined patterns or, in combination with discover stage 114, according to the application of computational pattern discovery techniques. Prepare stage 112 may comprise any of a number of data preparation steps, such as unit-of-measurement conversion, language translation of natural or other languages, averaging of values, alleviation of anomalies such as communication channel noise, interpolating or recreating missing data values and the like. Discover stage 114 may comprise steps of application of data pattern mining techniques, parameter sweeping, “slice-and-dice” analysis and many other techniques for revealing information of potential interest in the data under investigation. Share stage 116 may comprise steps of, for example, re-translating data from internal formats into product-specific formats for use by existing analysis tools, preparing accumulations, averages of data and other statistical representations of data, and structuring data into suitable transmission forms for sharing over networks of data analysis and utilization systems. The techniques to be applied in the discover stage 114 may imply a format into which the data must be transformed in prepare stage 112—for example, a linear data stream may need to be transformed into a matrix format where the discovery technology requires application of a sparse matrix vector multiplication.

Share stage 116 may comprise steps of, for example, re-translating data from internal formats into product-specific formats for use by existing analysis tools, preparing accumulations and averages of data, and structuring data into suitable transmission forms for sharing over networks of data analysis and utilization systems.

In the present data digest system technology, the components and stages of processing numbered 106, 108, 110, 112, 114, 116 each have input, output and internal processing constraints and parameters that, taken together, compose the configuration of a data digest pipeline. In conventional systems, such pipeline configurations are typically product-defined and permanently fixed, because of the complexities involved in arranging each stage in the pipeline, and because of the need for technical understanding in configuring the pipeline to accept data in a source-product-defined format and to process it into a consumer-product-defined format. In the present technology, template 104 is provided as a means of configuring the pipeline, being operable in communication with the components and stages of processing numbered 106, 108, 110, 112, 114, 116 to control the handling of data at each stage.

Template 104 may be provided anew, or it may be a template retrieved from storage either for reuse as-is or in a modified form. Thus, more sophisticated tuning of the processing pipeline can be accommodated by permitting a template 104 to be stored and possibly modified by a more technically competent user and then retrieved from storage for reuse to configure a pipeline tailored to meet a nearly-matching, but distinct, requirement.

It will be clear to one of skill in the art that each user's system may comprise a single type of data source device or many different types of device (a system of systems), producing the data stream 102. For an example of a user system having many different devices, consider an energy distribution monitoring system that may use smart meters, energy storage level sensors, sensors in home appliances, HVAC and light consumption sensors, local energy generation sensors (e.g. monitoring solar unit outputs), and energy transmission health/reliability monitors on transformers and syncro-phasers. Another example could be an automotive system that is reading in data from multiple devices embedded in a car such as GPS, speed sensors, engine monitoring devices, driver and passenger monitors, and external environment and condition sensors. Yet another example could be that of a home appliance company that reads back device data from sensors embedded in all their consumer products across multiple product lines where the data received from a wide array of device/sensors types describes how the consumer uses the products.

In all the cases a single device type can be considered a device system in its own right and the multi-device examples are systems of device systems. For any given single-device-type system there will be a unique mix of ingest, store, prepare, integrate, discover, and share services as shown in FIG. 1. In multiple-device-type systems, the mix is more complex.

Given that each user will have different preferred ways of consuming device system data it is expected that no two configurations of data digest will likely be the same. Because of this, opportunities to easily initially optimize systems for efficiency will be rare. Furthermore, it is expected that a device data system will not be a static entity but will evolve over time as more and more consuming applications attach to use its data via increased use of data digest's main services, which increases the difficulty in initially building optimal device data digest systems.

In every device system, metadata (behavioral data about the device data itself) can be gathered from any point in the data digest pipeline. For example:
At the point of ingest:
   The rate at which data is arriving;
   The protocols used to deliver the data;
   Data model and data descriptors;
   Any meta-data that is available from the device network that is delivering the data e.g.:
      Device security info;
      Network configuration and routing and point of device access;
      Network transport layer security applied;
      Network reliability and delivery statistics.
At the storage stage:
   How much data is stored in total;
   Data retention, archiving and deletion, patterns;
   Ratio of data written to data retrieved/read;
   Types of encryption applied to the data;
   User access patterns and type/number of users with permissions to access the data.
At the integrate stage:
   What other sources of data are being retrieved and being integrated into the device stream;
   Any metadata that comes with the other data source (which could also be related to previous ingest, storage, integrate, prepare, etc. stages already derived as metadata).
At the prepare stage:
   Types of transforms being applied to the data (e.g. graphs to lists, or streams to batches);
   Types of protocol conversions applied (e.g. JSON to XML);
   Types of mathematical or statistical operations applied to the data (e.g. conversion to mean and standard deviation, or application of signal component analysis).
At the discover stage:
   List of queries and searches that touch and reveal the data; including any metadata that accompanies the query/search:
      Types of users and organizations that issue the query/search;
      Types of consuming applications or M2M protocols that issue the query/search;
   Frequency of activation of data discovery service.
At the share stage:
   The rate at which data is being dispatched and consumed;
   The number of different consuming applications, users or machine-to-machine endpoints consuming the data;
   The protocols used to deliver the data to each consumer;
   Data model and data descriptors used to deliver the data to each consumer;
   Any metadata that is available from the device network that is delivering the data, e.g.:
      Device security info;
      Network configuration and routing and point of device access;
      Network transport layer security applied;
      Network reliability and delivery statistics.

The above-described data and metadata, along with the relationships between data and metadata entities and attributes, may be envisioned as a form of network. The network relationships thus include relationships between all of the metadata attributes extractable from the data digest pipeline stages, of which examples are listed above. These can be tapped off as raw data and the relationships between them discovered using machine learning or artificial intelligence (AI) tools and mathematical/statistical techniques for calculating correlation coefficients between sets of data such as cosine similarity or pointwise mutual information (as basic examples). These relationships between the various metadata form a semi-static graph view of the metadata (where nodes are metadata/data flows and sets and edges are calculated relationships). This graphical view of metadata can then be stored (perhaps in a separate graph database) and updated periodically based on the needs of the applications that are consuming this data—for example, by attaching another data digest pipeline on demand. If a metadata view is established for each part of a system (for example, and SDP), then other ML techniques can be applied to compare the different graphs of network relationships at the SDP layer and to pass them up to the next higher layer, SDP′.

This graph/network data can be consumed like any other data in the system—by attaching applications such as visualization apps or ML/AI driven applications serviced by data digest pipelines. These applications can perform functions such as system monitoring (SDP . . . SDP″ level) for anomalous behavior or for learning, tracking and optimizing flows of device data (at an FDP level).

Graph analytic techniques are well known in the data systems analysis art, and need no further explanation here. It is worth observing that a graph view rendered from metadata as described above is itself actually a hierarchical use of data digest in its own right in that it could easily be built from data digest components and methods. Equally, in other implementations, it could be a coarse grain function at the level of ingest, store, prepare, share etc.

Any or all of this data can feed the metadata input 502 and the full suite of data digest services and methods can be applied to this data to attach specific applications that can use the data to analyze and optimize the data delivery path of any given device system or system of systems, including the path of the data modelled by any given compilable data digest model. For example:
By applying analysis to the ingest and sharing metadata, a user could optimize the flow of data across the delivery networks in any of the device system examples on the basis that at certain times of the day more data is delivered or consumed than at other times in the day.
By applying analysis to the storage data to determine the optimal storage solution for a set of accrued device data e.g. either hot, cold, or archive storage.
By applying analysis to the integrate and ingest metadata to determine that a particular device type or device data model is most often integrated with a particular other data source and therefore could be integrated earlier and more efficiently in the system. This permits the establishment of a canonical relationship between the devices and consuming applications so that analysis of the collected metadata improves the efficiency of the data digest services in bridging between the device and the consuming application.
Any and all combinations of metadata can be used to build up machine learning models and derive statistical behavioral patterns that describe typical usage of a device system's data and any deviation from this typical usage can be considered as indicators of anomalous behavior—thus, anomalous behavior flags can be used to spot security threats and device system reliability issues.
Any and all combinations of metadata can be used as the basis of deriving value and utility metrics about the data and the data digest models that initially digested the data to inform decisions.

In general, many device systems will typically be created and deployed at sub-optimal performance and efficiency (relative to the full range of potential use cases and unforeseen data sharing and consuming modes of attachment to the data digest system). The use of metadata in the examples given can provide the basis to improve the end-to-end computing efficiency of the delivery networks and data digest services that complete a device system.

Turning now to FIG. 2, there is shown an example of a computer-implemented method 200 according to the presently described data digest technology. The method 200 begins at START 202, and at 204 a user (human or machine) is presented with a simple, constrained-language interface for defining the parameters (relating to the stages of processing numbered 106, 108, 110, 112, 114, 116) that are to configure and control the pipeline. The parameters include source device descriptors that define the data types and formats to be expected from data source devices, channel descriptors defining the communications channels over which data will be received into the data digest system, data flow dependencies—such as precedence rules for handling multiple input data streams, rules for integrating data streams from multiple devices, and the like—and consumer application constraints, such as the formats and data types that are required to enable particular consumer software applications to function to analyse the data from the data digest system. The pipeline description parameters are received at 206, stored at 208, and compiled to give a compiled template at 212. The compilation at 212 is operable to accept as input previously stored pipeline descriptions at 210. The stored pipeline descriptions of 208 are operable to be modified, if required, and reused by being input to the compiler at 212. The compiled template is stored at 214 and mapped at 218 to generate a configuration block, which is stored at 220. The stored compiled templates of 214 are operable to be modified, if required, and reused by being input to the mapper at 216. At 224, the configuration block is supplied to the data digest system to configure a pipeline at 226. The stored configuration block of 220 is operable to be modified, if required, and reused by being input to the data digest system at 224. The process completes at END step 228.

Turning now to FIG. 3, there is shown an example of a computer-implemented method 300 according to the presently described data digest technology. The method 300 is applicable in combination with the pipeline template technology of FIG. 2. The method 300 begins at START 302, and at 304 a set of constrained paradigms for structuring input, processing and output of data in the data digest system are established. Constrained paradigms will be described in further detail hereinbelow. At least one part of the set of constrained paradigms is directed to the control of input, internal and external data structures and formats in the data digest system. At 306, a data structure descriptor defining the structures of data available from a data source is received—this descriptor typically comprises data field names, data field lengths, data type definitions, data refresh rates, precision and frequency of measurements available, and the like. At 308, the data structure descriptor received at 306 is parsed, a process that typically involves recognition of the input descriptor elements and the insertion of syntactic and semantic markers to render the grammar of the descriptor visible to a subsequent processing component. At 310, the relevant constrained paradigm is identified (possibly by means of specific markers detected during parsing 308) and retrieved from storage to be applied 312 to the parsed data structure descriptor to generate a formal structure descriptor suitable for inclusion 314 in a compilable data model. If it is determined at test 316 that data content defined in the data structure descriptor will require transformation during the runtime operation of the data digest system, the formal structure descriptor is augmented at 318 and the augmentation is included in the compilable data model. Then, and also if no augmentation is required, test 320 determines (according to pre-established criteria) whether the compilable data model is suitable, either “as-is” or in modified form, for reuse. If so, the compilable data model is stored at 322. Then, and also if no reuse is contemplated, the compilable data model is input to the compiler at 324. The compiler generates a compiled executable 216 for data analysis from the compilable data model at 326 and the process completes at END step 328. The compiled executable 216 may then be operable during at least one of the ingest stage, the integrate stage, the store stage, the prepare stage, the discover stage and the share stage of an instance of operation of said data digest system.

A constrained paradigm according to the present technology comprises a humanly-usable interface offering a set of high-level descriptions that define intended uses and goals to be achieved by processing data through the data digest system and providing it to consuming applications. The constrained paradigm remains equally accessible via machine-to-machine interfaces—thus providing an input means to control the data digest system's behaviour that is source-agnostic. The use of a constrained paradigm provides users with the means to use humanly-readable, end-user specific definitions of the desired data digest system behaviour, without the need to understand the detailed internal workings of the data source device, the data digest system itself, or the consuming application.

For example, a user needs to meet a requirement to supply data in usable format to a Microsoft® Excel™ application and to Vendor Z's Artificial Intelligence application from 1000 smart meter devices calibrated in SI units supplied by Vendor X and 50,000 light sensor devices calibrated in United States Customary units supplied by Vendor Y. The data from the devices is delivered every 90 seconds, must be correlated in SI units rounded downward for reconciliation, and historical data must be retained for 30 days. The data is to be shared with a third-party Company A in Excel format. The user's company policy permits the data digest service to extract and use metadata relating to its use of the data digest system so that the system may be optimized. The constrained paradigm must therefore comprise means to define:

Ingest: data source definitions for Vendor X smart meter devices and Vendor Y light sensor devices.

Store: store both smart meter and light sensor data and retain for 30 days.

Prepare: convert light sensor data to SI units, populate Excel spreadsheet with both sets of data, prepare data in Vendor Z's Artificial Intelligence application input format.

Share: share data in Excel format with Company A.

Metadata: permit logging at all stages.

In an exemplary implementation of the present technology, data source and preparation definitions derived from the constrained paradigm are used to create the formal structure descriptor and its augmentation for use by the data digest model compiler to generate the compiled executable that will be used in the running data digest system. Other definitions derived from the constrained paradigm are used to control other aspects of the data digest system, such as the storage of the data.

Broadly, then, the various implementations of the present technology provide the building blocks for the construction of digests of data suitable for data analysis by multiple consumers or subscribers, with full independence from the technicalities of the data sources and communications channels used, and thus decouples source devices from the data they generate. In effect, the data sources and the configurations of the data digest pipeline are virtualized, freeing the provision of data for analysis from constraints and limitations associated with particular device types and with the means by which the data is accumulated and transmitted.

Using the processes described above, the compiled data digest model can be interpreted by the data digest pipeline system by mapping its elements according to Application Programming Interface (API) constructs that are available. Mapping is thus a process of interpreting a compiled data digest model. Compiling a data digest model means it can be matched against the APIs and allowable modes for each data digest processing stage that may be applied.

The mapping process is essentially taking this compiled form and interpreting it to stimulate the appropriate APIs to set up and run the data digest pipeline. The types of parameters and constraints provided as input are descriptors and any policy inputs, and these need to be reconciled with what the APIs allow as a runtime implementation.

In one implementation of the present technology, the template is modifiable to enable the generation of at least one further template for processing data content that can be emitted by a second or further physical data source device. In this way, stored templates may serve as a pool of models to save time in developing configuration blocks to control the data digest processing of future data structures that may be emitted, either by existing data source devices, or by newly-developed devices.

Turning now to FIG. 4, there is shown a further example of a computer-implemented method 400 that uses a template according to the presently described data digest technology. The method 400 begins at START 402, and at 404 a data stream is received from many data sources in a variety data types having differing specific data rates, data patterns, data formats and data shapes as described in relation to the data stream input 102. At 406, the data in the configured pipeline is transformed using a compilable data model to a predetermined format that is agnostic to the variety of data types such as consumption pattern, rate or shape of the data. The data transformed to the predetermined format is received and stored at 408 in the form of multiple canonical data formats under control of the template. The data at 408 is now stored in a neutral format that can in practice be communicated with any number of tools having the appropriate application software to retrieve and read the data. In 410 any one or more of the multiple canonical data formats are retrieved according to criteria in the template and in 412 applied to a value algorithm for data processing. In 412 the value algorithm determined by the template transforms the data using the compilable data model to a form required by an endpoint, for example, in 414 the data may be transformed to a sparse matrix format, in 416 into a file format or in 418 into formats compatible with XML or JSON usage. At 420, data that has been transformed in the sparse matrix format is output as a data stream to an application for its use and analysis by the application at the endpoint at 422. For example, such a use may be in speech recognition and machine learning. The process completes at END step 424.

In one implementation, the present technology may be further provided with instrumentation operable under control of the template during at least one of the parsing, restructuring, augmenting or inputting steps to generate a data set for subsequent analysis by the data digest system. The technology thus adapted achieves reflexivity, enabling machine-learning techniques to analyse the feedback to improve future operation of the data digest system. Thus, at any point in the data digest pipeline, behavioural data may be gathered and processed. For example, gathered data can be metadata related to the received input data or the receiving of the input data such as at 404A. Gathered data can be metadata related to the transformations applied to data stream at 406A. Gathered data can be metadata related to the value algorithm processing at 412A. Gathered data can be metadata related to the output data stream at 420A and consumption of the output data stream by the endpoint 422A.

FIG. 5 shows one example of a metadata digest pipeline according to the presently described technology. At any stage of 404A, 406A, 412A, 420A and 422A including at stages not shown in FIG. 2, a metadata stream input 502 may be input into a vertical data digest system 500. As described in relation to FIG. 1, the data digest system 500 comprises an ingest stage 504, a storage 506, an analysis, diagnostics and value stage 508 to generate digested information 510.

According to the presently described technology, foregoing techniques enable an IoT service or platform to track and rank data sources from available sensor data, based on multiple factors including nature of content, geography, data quality, reliability, demand and performance. According to present techniques, contributing ranking factors can be collected from the control plans of the devices themselves, the delivery networks and the data processing pipelines in the cloud. Indeed, virtually any data in the control plan can contribute to the tracking and ranking of data sources. Ranking data enables applications and users to select data sources based on historical patterns such as technical reliability, that is being able to take into account factors such as downtime, data size, security of data, age, trust and source of the data.

Ranking data may be a dynamic feature rather than a static feature. In present techniques, the relative ranking of data may change depending on the metrics specified as important by the application or user. Such a technique is beneficial to the flexibility of the service since different applications or users can have different technical requirements for their service such as age of data, update frequency, volume and so in this way ranking is context specific. Additional flexibility can be introduced into the service as raw factors and ranking data is supplied to the application or user to allow them to apply their own processing and algorithms to make their own determinations about the value and quality of the device data that is received.

An IoT service or platform may operate on raw data from devices or alternatively from virtualised data via decoupled data streams. Such decoupled data streams built upon the same raw data may carry different levels of data abstraction/content update frequency and may result in different rankings depending on the characteristics of the data required. Possible metrics include (without limitation):
Availability
Use by third parties, access frequency and consumption patterns;
Subscriber feedback which may be automated;
Reliability;
Integrity of data;
Level of trust placed on the data by the user or application;
Realtime/non-real time/update frequency;
Detail/accuracy
Data stream from a single source vs merged data stream from multiple sources;
Security level of the data stream.

As a route to improving the accuracy of the data, there may be provided an automatic data self-enrichment. The self-enrichment may employ usage attributes such as data usage, user identity, purpose of usage and number of users. In any data ranking system, a subset of data sources may become more trusted than other sources. Such more trusted sources of data may result in a tiered, hierarchical ordering of data which in turn may lead to the provision of a data “hall of fame” per category of data. Such an ordering of data can enable a new user to immediately access most relevant data for its purpose. Other embodiments for data self-enrichment include data criticality such as a measure of how important a data stream is to a set of consuming applications and a data “reputation” for specific topics automatically based on actual usage of data. Such improvement may provide a self-review or other automated review and ranking framework for the data, which subsequently may lead to data value or other abstract services that exchange data governed by measures of value or utility.

In further embodiments, automated feedback to an operator/sensors provider/cloud provider may also be provided to identify better or weaker rated devices and data sources to allow a provider to choose whether to improve, categorise or prioritise access to higher ranking devices; or modify characteristics such as increasing/decreasing notifications, propose backups and alternatives. Accordingly, in FIG. 6 a data sharing platform 600 comprises both a raw data sourcing platform 602 and a decoupled data sourcing platform 604, each in electronic communication over a network that also comprises a data digest system 601 according to the presently disclosed technology. Raw data sourcing platform 602 comprises many hundreds, indeed thousands of customer IoT devices 606 connected to a network 608. Substantial data flow 610 occurs across the network 608 and data metrics may be assessed at data flow module 612. Such data metrics assessed at the data flow module 612 include data flow duration and flow volume in both packets and bytes. Various granularity of data flow may be analysed including destination network and host pair. Data metrics gathered at data flow module 612 may be communicated to a data value exchange module 614.

Data port 616 may provide a metadata analysis according to present techniques including for the tracking and ranking of data sources from available sensor data, based on multiple factors including nature of content, geography, data quality, reliability, demand and performance for use in user or application consumption 618.

Decoupled data sourcing platform 604 comprises an IoT platform 620 having ownership by a specific entity A. Entity A in the present embodiment allows sharing of its IoT devices across network 622. Substantial data flow 624 occurs across the network 622 and data metrics may be assessed at a data flow module 626. Such data metrics assessed at the data flow module 626 include data flow duration and flow volume in both packets and bytes. Various granularity of data flow may be analysed including destination network and host pair. Data metrics gathered at data flow module 626 may be communicated to a data value exchange module 628. Also in the present embodiment, a virtual device port 629 enables data sharing between multiple virtual devices 630. Such data sharing may provide further metrics to the data flow module 626 to adjust any output of the data value exchange module 628.

Examples of metadata analysis providing value-add for a user or application include:
estimating the criticality of data when used in a system to determine whether to keep the source of data or to get more of that type of device data;
to assess risk or vulnerability of a device data system by assigning value metrics to the sources of data;
to apply an integrity or trust value to the data in setting where a user or application may want to share the data with a 3^{rd} party such as for data trading or value;
to apply a use case or industry specific value/score to the data when sharing data between 3^{rd} parties;
in a future machine to machine negotiation for access to data, applying integrity or trust value criteria that is derived from the consuming machines analytic needs.

In the examples there are many alternative sources of data that can be compared to each other, and the comparisons can be done via applications that calculate utility and that are attached to the metadata layers of data digest. Attached applications that make comparisons will have to have visibility into systems of systems of devices or systems of systems of systems of devices.

Some examples of how to calculate utility in data include:
criticality of data (for example, in an energy distribution system)
   all energy flow sensors across an energy system to feed data into at least 1 consuming application (as captured in data digest meta data);
   a subset Y of energy flow sensors at the core of the energy grid contribute to every consuming application in the enterprise/operation;
   a subset of Y, subset Z, also is shared out to 3rd party maintenance and security applications outside of the enterprise/operation;
   by applying a simple function of #-of-consuming-apps & #-of-3^{rd} party-consumers, Y could be scored as the most critical devices in the system and warrant extra care and attention and security;
   the critical devices are those devices having the highest value or utility in the system from a criticality perspective.
Risk/vulnerability (for example, in a fleet of automotive vehicles)
   all sensors or device streams in a fleet can be scored against a security ranking by polling any security information pertaining to TLS and storage encryption (as captured in data digest metadata);
   all streams can have stability scores based on data delivery regularity or deviations from norms (# of anomalies) calculated from the metadata set;
   a function of stability and level of security can be used to score which devices appear unstable and vulnerable and hence pose a risk to the safety of a vehicle;
   . . . these devices are the most ‘valuable’ in a safety/security audit scenario.
Utility value—for example, an engineer wants to study temperature data (e.g. temperature in Cambridge Science Park) in their system and wants to obtain data from an IoT platform provider.
   The provider has n sources of temperature data ranked and scored by a function of #-of-consuming apps, level of security, reliability of delivery of data, lifetime volume of data delivered, number of existing 3^{rd} party sharing relationships, number of anomalies etc. (all signals present in the data digest metadata layer);
   . . . the ranking and scores are a use case specific descriptor of which source of data is worse of best or in between in terms of trust and integrity;
   The person can make a request to access the trusted data.
   A Machine to Machine negotiation for data scenario includes finding data sources that meet some predetermined criteria such as a secure source of temperature data that has been consumed by 10 other analytics applications. Or, as a value function of all of the critical, risk, vulnerability and utility values provided.

Turning now to FIG. 7, there is shown a method 700 of harvesting, generating or otherwise generally providing data according to a ranking. The method begins at 702 and at 704 a data digest system as described herein provides an analytical representation such as a metadata representation of various data entities, sources and network relationships in a network. At 706 a rule schema for ranking the data is established by some predetermined means accessible and adjustable by users depending on various factors. The rule schema may be created and manipulated by a called application. At 708, the rule schema is stored for use on demand at some point in the IoT platform or data digest system. According to present techniques, at some point a request 710 is made from a data consumer to request data with some conditions applied which conditions are aided through providing and analyzing the data ranking. At 710 the request is received at the data digest entity and at least a segment of a data stream comprising at least one said data entity from at least one ranked data source is received. At 712 a rule engine, which may be a called application, is run to apply the stored rule schemas against the segment of data by linking associated ranking metadata with the segment of data. Responsive to the associated ranking metadata at 714 matching the requested ranking metadata, the method populates an output data structure from data in the data segment by the data digest and at 716 the populated data structure is communicated to the data consumer in a manner determined by the data digest configuration. The method ends at 718.

In addition to the constraints and requirements imposed by the available inputs, internal dependencies, processing constraints and consumer application needs, higher-level controls may need to be applied to data digest pipelines, and this can be achieved using policies, that is, rules on what can happen to data or limits on what can be done. In one example, a policy may say that a certain user is only authorized to access the average of data or some aggregate thereof. So, for example, personally identifiable data in health-related records may need to be protected from exposure, and this can be controlled by means of an appropriate policy. In another example, a consuming application may be restricted so that it will only consume 2 Gbytes of data. In a further example, there may be a requirement that stored data cannot be deleted or modified for 31 days to satisfy a legal requirement. These and other policies can be applied to the creation of a compiled executable by taking a policy descriptor. In one implementation, compiled data models may also be exported and checked against policies by a third-party application. The application of policies need not be restricted to main data flow pipelines, but may also be applied to metadata, and thus metadata for FDP, SDP′ SDP″ . . . descriptions of the system as described above can be also checked against policies at the next level up.

In every stage of, or operation permissible in, a data digest pipeline—a policy enforcement point can be inserted that gates the operation with a yes/no option to execute if the policy says so. The configuration of these policy enforcement points can be configured at the mapping stage of creating a pipeline or under the control of the consuming application (if, for example, a different user with different data access rights logs in to the consuming application).

As will be appreciated by one skilled in the art, the present technique may be embodied as a system, method or computer program product. Accordingly, the present technique may take the form of an entirely hardware embodiment, an entirely software embodiment, or an embodiment combining software and hardware. Where the word “component” is used, it will be understood by one of ordinary skill in the art to refer to any portion of any of the above embodiments.

Furthermore, the present technique may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction-set to high-level compiled or interpreted language constructs.

It will also be clear to one of skill in the art that all or part of a logical method according to embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In one alternative, an embodiment of the present techniques may be realized in the form of a computer implemented method of deploying a service comprising steps of deploying computer program code operable to, when deployed into a computer infrastructure or network and executed thereon, cause said computer system or network to perform all the steps of the method.

In a further alternative, an embodiment of the present technique may be realized in the form of a data carrier having functional data thereon, said functional data comprising functional computer data structures to, when loaded into a computer system or network and operated upon thereby, enable said computer system to perform all the steps of the method.

It will be clear to one skilled in the art that many improvements and modifications can be made to the foregoing exemplary embodiments without departing from the scope of the present technique.

1. A machine implemented method for generating a data digest template for configuring a pipeline in a data digest system, the method comprising:
receiving a pipeline description comprising a set of pipeline parameters operable by the data digest system, the pipeline parameters comprising at least one of a data source device descriptor, a communication channel descriptor, a flow dependency and a consuming application constraint;
storing the pipeline description for modification and reuse;
compiling the pipeline description using a template compiler to generate a compiled template;
storing the compiled template for modification and reuse;
mapping the compiled template into at least one data digest system configuration block to generate a mapped configuration block;
storing the at least one data digest system mapped configuration block for modification and reuse; and
supplying the at least one data digest system mapped configuration block to the data digest system to configure the pipeline.

2. The machine-implemented method of claim 1, where said receiving a pipeline description comprises retrieving a pipeline description previously stored for modification and reuse.

3. The machine-implemented method according to claim 1, where said mapping the compiled template further comprises retrieving a compiled template previously stored for modification and reuse.

4. The machine-implemented method according to claim 1, where said supplying the at least one data digest system configuration block further comprises retrieving a data digest system configuration block previously stored for modification and reuse.

5. The machine-implemented method according to any claim 1, further comprising a process of modification and reuse of at least one of a pipeline description, a compiled template, and a data digest system configuration block.

6. The machine-implemented method according to claim 1, where said receiving a pipeline description comprises extracting parameters from a constrained language paradigm.

7. The machine-implemented method according to claim 1, where said constrained language paradigm comprises parameters represented in a graphical modelling canvas.

8. The machine-implemented method according to claim 1, where said data digest system configuration block comprises data structures and processing directives for at least one of an ingest stage, a store stage, an integrate stage, a prepare stage, a discover stage and a share stage of said data digest system.

9. An electronic apparatus for generating a data digest template for configuring a pipeline in a data digest system, the apparatus comprising:
receiver logic operable to receive a pipeline description comprising a set of pipeline parameters operable by the data digest system, the pipeline parameters comprising at least one of a data source device descriptor, a communication channel descriptor, a flow dependency and a consuming application constraint;
first storage operable to store the pipeline description for modification and reuse;
template compiler logic operable to compile the pipeline description to generate a compiled template;
second storage operable to store the compiled template for modification and reuse;
mapper logic operable to map the compiled template into at least one data digest system configuration block;
third storage operable to store the at least one data digest system configuration block for modification and reuse; and
communication logic operable to supply the at least one data digest system configuration block to the data digest system to configure the pipeline.

10. The apparatus as claimed in claim 9, where said receiver logic operable to receive a pipeline description comprises first retrieval logic operable to retrieve a pipeline description previously stored for modification and reuse.

11. The apparatus as claimed in claim 9, where said mapper logic operable to map the compiled template comprises second retrieval logic operable to retrieve a compiled template previously stored for modification and reuse.

12. The apparatus as claimed in claim 9, where said communication logic operable to supply comprises third retrieval logic operable to retrieve a data digest system configuration block previously stored for modification and reuse.

13. The apparatus as claimed in claim 9, further comprising a process of modification and reuse of at least one of a pipeline description, a compiled template, and a data digest system configuration block.

14. The apparatus as claimed in claim 9, where said receiver logic operable to receive a pipeline description comprises extraction logic operable to extract parameters from a constrained language paradigm.

15. The apparatus as claimed in claim 14, where said extraction logic operable to extract parameters from a constrained language paradigm comprises logic operable to extract parameters represented in a graphical modelling canvas.

16. A computer program product comprising a computer-readable storage medium storing computer program code operable, when loaded into a computer and executed thereon, to cause said computer to generate a data digest template for configuring a pipeline in a data digest system by:
receiving a pipeline description comprising a set of pipeline parameters operable by the data digest system, the pipeline parameters comprising at least one of a data source device descriptor, a communication channel descriptor, a flow dependency and a consuming application constraint;
storing the pipeline description for modification and reuse;
compiling the pipeline description using a template compiler to generate a compiled template;
storing the compiled template for modification and reuse;
mapping the compiled template into at least one data digest system configuration block;
storing the at least one data digest system configuration block for modification and reuse; and
supplying the at least one data digest system configuration block to the data digest system to configure the pipeline.
